(19) United States
(12) Patent Application Publication
(10) Pub. No.: US 2007/0252103 A1
(43) Pub. Date: Nov. 1, 2007

(54) DIAPHRAGM VALVE

(76) Inventor: Ting-Kuo WU, Tucheng City (TW)

Correspondence Address: Rabin & Berdo, P.C., Suite 500, 1101 14th Street, Washington, DC, 20005, US

(21) Appl. No.: 11/684,274

(22) Filed: Mar. 9, 2007

(30) Foreign Application Priority Data
Apr. 28, 2006 (TW) 095207260

(51) Int. Cl. F16K 31/00

(52) U.S. Cl. 251/335.2

(57) ABSTRACT

A diaphragm valve has a body, a top cover and a diaphragm assembly. The body has an open top, a primary chamber, an inlet passage and an outlet passage. The top cover is mounted on the open top of the body and has a balance chamber. The diaphragm assembly is mounted between the top cover and the body, extends in the primary chamber and has a diaphragm, a shaft and a seal. The diaphragm is mounted between the top cover and the body. The shaft is longitudinal, is mounted on the diaphragm and extends downward in the primary. The seal is mounted on the shaft and selectively seals the outlet passage. The longitudinal shaft allows the air pumped into the inlet passage to smoothly flow out of the outlet passage without causing turbulence.

### BACKGROUND OF THE INVENTION

1. Field of the Invention

The present invention relates to a valve, and more particularly to a diaphragm valve that is heatproof, provides a high flow rate and may be used in concrete plants, iron and steel plants, coal plants and air pollution prevention equipment.

2. Description of Related Art

Diaphragm valves are generally used in industrial plants such as feed mills, concrete plants, iron and steel plants, coal plants and air pollution prevention equipment to blow off the powder or dust on dust cloths for collection of the powder or dust. The diaphragm valves may be used with an air controller such as an air pump.

With reference to FIGS. 3 and 4, a conventional diaphragm valve (70) comprises a body (71), a primary chamber (712), an inlet tube (73), an outlet tube (75), a top cover (72), a balance chamber (711), a diaphragm (76) and a spring (714). The body (71) has a sidewall, an open top (713) and a bottom. The primary chamber (712) is defined in the body (71) and communicates with the open top (713). The inlet tube (73) is formed on and protrudes from the sidewall of the body (71) and has an inlet passage (731) and an air guide passage (732). The inlet passage (731) is defined axially through the inlet tube (73) and communicates with primary chamber (711). The air guide passage (732) is defined radially through the inlet tube (73) and communicates with the inlet passage (731). The outlet tube (75) is formed on the bottom of the body (71), protrudes upward in the primary chamber (712) and has a sidewall and an outlet passage (751) defined axially through the outlet tube (75). The top cover (72) is mounted on and covers the open top (713) of the body (71) and has a discharge hole (74). The discharge hole (74) is defined through the top cover (72) and is sealed selectively by an external sealing device. The balance chamber (711) is defined in the top cover (72) above the primary chamber (712) and communicates with the air guide passage (732). The diaphragm (76) is made of resilient rubber, is mounted between the body (71) and the top cover (72), separates the balance chamber (711) from the primary chamber (712) and has a seal (761) mounted on the diaphragm (76) and selectively seals the outlet passage (751). The spring (714) is mounted between the top cover (72) and the diaphragm (76) and biases the seal (761) to abut the outlet tube (75) to seal the outlet passage (751).

The air flows partially into the balance chamber (711) through the air guide passage (732) when air flows into the primary chamber (712) through the inlet passage (731). The air pressure in the balance chamber (711) is equal to that in the primary chamber (712) and the spring (714) keeps the seal (761) sealing the outlet passage (751) with an elastic force when the discharge hole (74) in the top cover (72) is sealed by the external sealing device. Alternatively, the air pressure in the balance chamber (711) is smaller than that in the primary chamber (712) and the spring (714) is compressed by the upward expanding diaphragm (76) to open the outlet passage (751) when the discharge hole (74) is open to discharge the air in the balance chamber (711).

However, a high ambient temperature excessively heats the body (71), the top cover (72) and the diaphragm (76) through the thermal conduction and makes the diaphragm (76) made of rubber melt and break. Accordingly, the conventional diaphragm valve (70) has a very limited operational ambient temperature. Furthermore, the sidewall of the outlet tube (75) faces the inlet passage (731) and blocks and makes the air from the inlet passage (731) to the outlet passage (751) flow unevenly and even causes an air turbulence slowing down the air flow out of the outlet passage (751). Accordingly, the efficiency of the diaphragm valve (70) is lowered down.

With reference to FIG. 5, another conventional diaphragm valve (80) slightly mitigates the problem of the blocked and slowed air and comprises a body, a primary chamber (812), an inlet tube, an outlet tube, a top cover, a balance chamber, a diaphragm and a spring. The inlet tube has an inlet passage (831), the outlet tube has an outlet passage (851). The outlet tube is formed on the bottom of the body and protrudes downward. The diaphragm is mounted between the top cover and the body and has a seal (861). The seal (861) is reverse-cup-shaped, is mounted on the diaphragm and protrudes downward to selectively seal the outlet passage (851). When the seal (861) is lifted up due to an air pressure unbalance between the primary and balance chamber, the air from the inlet passage (831) to the outlet passage (851) passes barely through a gap between the lifted seal (861) and the outlet tube. However, a sidewall of the seal (861) still blocks considerable air from the inlet passage (831) and therefore lowers the efficiency of the diaphragm valve (80).

To overcome the shortcomings, the present invention provides a diaphragm valve to mitigate or obviate the aforementioned problems.

### SUMMARY OF THE INVENTION

The main objective of the invention is to provide a diaphragm valve that is heatproof, provides a high flow rate and may be used in concrete plants, iron and steel plants, coal plants and air pollution prevention equipment.

A diaphragm valve in accordance with the present invention comprises a body, a top cover and diaphragm assembly. The body has an open top, a primary chamber, an inlet passage and an outlet passage. The top cover is mounted on the open top of the body and has a balance chamber. The diaphragm assembly is mounted between the top cover and the body, extends in the primary chamber and has a diaphragm, a shaft and a seal. The diaphragm is mounted between the top cover and the body. The shaft is longitudinal, is mounted on the diaphragm and extends downward in the primary. The seal is mounted on the shaft and selectively seals the outlet passage.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional side view of a diaphragm valve in accordance with the present invention with the seal sealing the outlet passage;

FIG. 2 is an operational cross sectional side view of a diaphragm valve in FIG. 1 with the seal separating from the outlet tube to open the outlet passage;

FIG. 3 is a cross sectional side view of a conventional diaphragm valve in accordance with the prior art with the seal sealing the outlet passage;

FIG. 4 is an operational cross sectional side view of the conventional diaphragm valve in FIG. 3 with the seal separating from the outlet tube to open the outlet passage; and

FIG. 5 is a cross sectional side view of another conventional diaphragm valve in accordance with the prior art with the reverse-cup-shaped seal.

### DETAILED DESCRIPTION OF THE PREFERRED EMBODIMENT

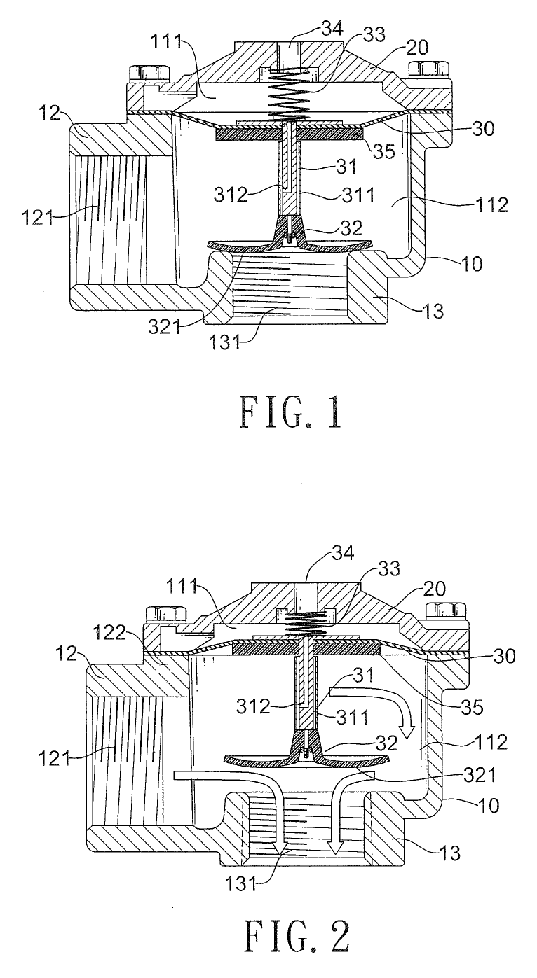

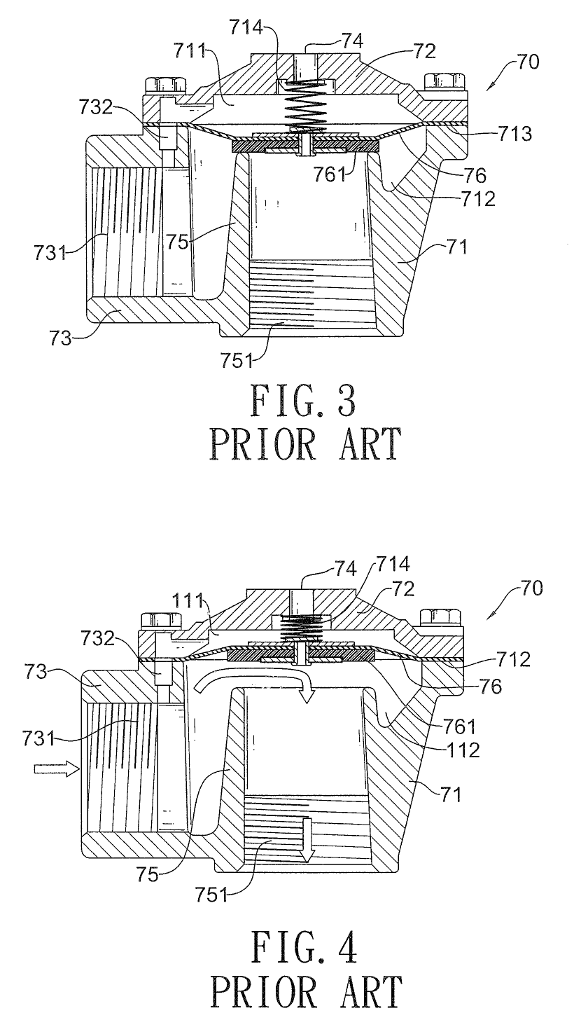

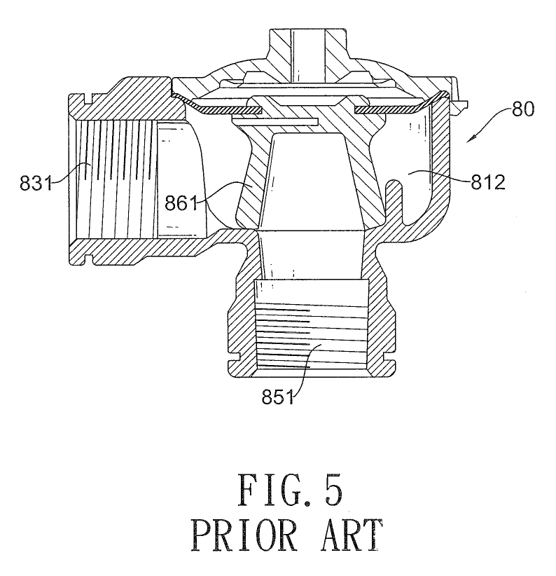

With reference to FIGS. 1 and 2, a diaphragm valve in accordance with the present invention is used in industrial plants such as feed mills, concrete plants, iron and steel plants, coal plants and air pollution prevention equipment to blow off powder or dust on dust cloths for collection of the powder or dust. The diaphragm valves may be used with an air controller such as an air pump.

The diaphragm valve comprises a body (10), a top cover (20) and a diaphragm assembly.

The body (10) has an open top, a bottom, a sidewall, a primary chamber (112), an inlet tube (12) and an outlet tube (13).

The primary chamber (112) is defined in the body (10) and communicates with the open top.

The inlet tube (12) is formed on and protrudes out from the sidewall of the body (10) and has an inlet passage (121). The inlet passage (121) is defined axially through the inlet tube (12) and communicates with the primary chamber (112). The inlet tube (12) may be connected to an air pump so air may be pumped into the primary chamber (112) through the inlet passage (121).

The outlet tube (13) is formed on and protrudes down from the bottom of the body (10) and has an annular top edge and an outlet passage (131). The annular top edge may be circular. The outlet passage (131) is defined axially through the outlet tube (13) and communicates with the primary chamber (112). Air pumped into the primary chamber (112) flows out of the outlet passage (131) to blow off the powder or dust on the dust cloths.

The top cover (20) is mounted on and covers the open top of the body (10) and has a bottom, a balance chamber (111) and a discharge hole (34).

The balance chamber (111) is defined in the bottom of the top cover (20) above the primary chamber (112).

The discharge hole (34) is defined through the top cover (20) and communicates with the balance chamber (111). The discharge hole (34) may be sealed by an external sealing device.

The diaphragm assembly is mounted between the body (10) and the top cover (20), extends in the primary chamber (112) and has a diaphragm (30), a shaft (31), a seal (32), a spring (33) and a weight (35).

The diaphragm (30) is made of resilient material such as rubber, is mounted between the body (10) and the top cover (20), separates the balance chamber (111) from the primary chamber (112) and has a central segment capable of moving up and down.

The shaft (31) is longitudinal, is mounted on the central segment of the diaphragm (30), extends down in the primary chamber (112), faces the inlet passage (121) and has a top end, a bottom end, an annular outer surface, an air guide channel (312) and a heat-dissipating sleeve (311). The air guide channel (312) is L-shaped, is defined through the shaft (31), communicates with the balance chamber (111) and the primary chamber (112) and has an upper opening at the top end of the shaft (31) and a lower opening at the annular outer surface. The heat-dissipating sleeve (311) is made of metal such as aluminum or copper, is mounted around the shaft (31) and dissipates heat from the shaft (31).

The seal (32) is made of metal, plastic or rubber, is curved, is mounted on the bottom end and selectively abuts the annular top edge of the outlet tube (13) completely to seal the outlet passage (131). The seal (32) may have a spherical bottom surface (321) corresponding to and capable of completely abutting the annular top edge of the inlet tube (13) being circular. The seal (32) seals the outlet passage (131) when the central segment of the diaphragm (30) moves down. Heat of the seal (32) is also dissipated by the sleeve (311) through the shaft (31).

The spring (33) is mounted between the top cover (20) and the central segment of the diaphragm (30) and biases the seal (32) to seal the outlet passage (131).

The weight (35) is mounted on the central segment of the diaphragm (30) to keep the central segment in a lowest position and keep the seal (32) sealing the outlet passage (131).

The air flows partially into the balance chamber (111) through the air guide channel (312) when air is pumped into the primary chamber (112) through the inlet passage (121). The air pressure in the balance chamber (111) is equal to that in the primary chamber (112) and the spring (33) keeps the seal (32) sealing the outlet passage (131) with an elastic force when the discharge hole (34) in the top cover (20) is sealed by the external sealing device.

With reference to FIG. 2, When the discharge hole (34) is open to discharge the air in the balance chamber (111), the air pressure in the balance chamber (111) is smaller than that in the primary chamber (112). Thus, the central segment of the diaphragm (30) moves up and compresses the spring (33) to separate the seal (32) from the outlet tube (13) and open the outlet passage (131). Then the air in the primary chamber (112) flows out of the diaphragm valve to blow the dust cloths.

The longitudinal shaft facing the inlet passage (121) allows the air pumped into the inlet passage (121) to smoothly flow out of outlet passage (131) through the primary chamber (112) without causing turbulence. Accordingly, the diaphragm valve has a high operational efficiency. Furthermore, the spherical bottom surface (321) of the seal (32) entirely abuts the circular annular top edge of the inlet tube (13) even the seal (32) is inclined or displace when moving down. Accordingly, the seal (32) always seals the outlet passage (131) hermetically without leakage.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A diaphragm valve comprising:
a body having an open top, a bottom and a sidewall and further having
a primary chamber defined in the body and communicating with the open top;
an inlet tube formed on and protruding from the sidewall of the body and having an inlet passage defined axially through the inlet tube and communicating with the primary chamber; and
an outlet tube formed on and protruding down from the bottom of the body and having an annular top edge and an outer passage defined axially through the outlet tube and communicating with the primary chamber;
a top cover mounted on and covering the open top of the body and having a bottom and a balance chamber defined in the top cover above the primary chamber; and
a diaphragm assembly mounted between the body and the top cover, extending in the primary chamber and having
a diaphragm made of resilient material, mounted between the body and the top cover, separating the balance chamber from the primary chamber and having a central segment capable of moving up and down;
a shaft being longitudinal, mounted on the central segment of the diaphragm, extending down in the primary chamber and facing the inlet passage;
a seal being curved, mounted on the shaft and selectively abutting the annular top edge of the outlet tube to seal the outlet passage; and
a spring mounted between the top cover and the central segment of the diaphragm and biasing the seal to seal the outlet passage.

2. The diaphragm valve as claimed in claim 1, wherein the shaft further has a heat-dissipating sleeve made of metal and mounted around the shaft.

3. The diaphragm valve as claimed in claim 1, wherein the diaphragm assembly further has a weight mounted on the central segment, keeping the central segment in a lowest position and keeping the seal sealing the outlet passage.

4. The diaphragm valve as claimed in claim 1, wherein the seal is made of metal.

5. The diaphragm valve as claimed in claim 1, wherein the seal is made of plastic.

6. The diaphragm valve as claimed in claim 1, wherein the seal is made of rubber.

7. The diaphragm valve as claimed in claim 1, wherein:
the top cover further has a discharge hole defined through the top cover and communicating with the balance chamber; and
the shaft further has a top end, a bottom end, an annular outer surface and an air guide channel defined through the shaft and communicating with the balance chamber and the primary chamber.

8. The diaphragm valve as claimed in claim 7, wherein the air guide channel is L-shaped and having an upper opening at the top end and a lower opening at the annular outer surface of the shaft.

9. The diaphragm valve as claimed in claim 1, wherein:
the annular top edge of the outlet tube is circular; and
the seal further has a spherical bottom surface corresponding to and capable of completely abutting the annular top edge being circular.
